(19) United States
(12) Patent Application Publication
(10) Pub. No.: US 2019/0327519 A1
(43) Pub. Date: Oct. 24, 2019

(54) NETWORK STREAMING APPARATUS AND OPERATION METHOD OF THE SAME

(71) Applicant: Realtek Semiconductor Corporation, Hsinchu (TW)

(72) Inventors: Ming-Tsung Tsai, Taoyuan (TW); Huang-Lin Kuo, Taipei (TW)

(21) Appl. No.: 16/166,343

(22) Filed: Oct. 22, 2018

(30) Foreign Application Priority Data
Apr. 18, 2018 (TW) 107113252

(51) Int. Cl. H04N 21/4363; H04N 21/643; H04N 21/4367; G06F 1/04; H04W 72/04

(52) U.S. Cl. CPC H04N 21/43637; H04N 21/64322; H04W 72/0453; G06F 1/04; H04N 21/4367

(57) ABSTRACT

A network streaming device that includes a wireless transmission module and a host module is provided. The wireless transmission module is configured to perform wireless communication with an external wireless access point through a wireless channel within a wireless frequency band. The host module is configured to be coupled with the wireless transmission module and generates a clock signal to the wireless transmission module according to a frequency range of the wireless channel such that the wireless transmission module operates according to the clock signal. The host module determines an operation frequency of the clock signal according to the frequency range of the wireless channel such that a plurality of harmonics of the clock signal generated according to the operation frequency are not within the frequency range.

### RELATED APPLICATIONS

This application claims priority to Taiwan Application Serial Number 107113252, filed Apr. 18, 2018, which is herein incorporated by reference.

### BACKGROUND

### Field of Invention

The present invention relates to a network streaming technology. More particularly, the present invention relates to a network streaming apparatus and a network streaming apparatus operation method.

### Description of Related Art

In recent years, the Internet protocol television (IPTV) and set top box (STB) become mainstream multimedia equipments of every family due to the development of the network streaming technology. By using the network streaming of the multimedia information, the user can watch diverse channels of programs through the network. When the network streaming apparatus is in operation, a wireless transmission circuit is required to access the network stream from a remote server. However, the operation clock signal in the network streaming apparatus usually generates harmonics to interfere the wireless transmission circuit.

Accordingly, what is needed is a network streaming apparatus and a network streaming apparatus operation method to address the issues mentioned above.

### SUMMARY

An aspect of the present invention is to provide a network streaming apparatus that includes a wireless transmission module and a host module. The wireless transmission module is configured to perform wireless communication with an external wireless access point (AP) through a wireless channel of a wireless frequency band. The host module is configured to be electrically coupled to the wireless transmission module and to generate a clock signal to the wireless transmission module according to a frequency range of the wireless channel such that the wireless transmission module operates according to the clock signal. The host module determines an operation frequency of the clock signal according to the frequency range of the wireless channel such that a plurality of harmonics generated by the clock signal according to the operation frequency are not within the frequency range.

Another aspect of the present invention is to provide a network streaming apparatus operation method used in a network streaming apparatus, wherein the network streaming apparatus operation method includes the steps outlined below. Wireless communication is performed with an external wireless AP through a wireless channel of a wireless frequency band by a wireless communication module. An operation frequency of a clock signal is determined according to a frequency range of the wireless channel by a host module electrically coupled to the wireless transmission module such that a plurality of harmonics generated by the clock signal according to the operation frequency are not within the frequency range. The clock signal having the operation frequency is generated to the wireless transmission module by the host module such that the wireless transmission module operates according to the clock signal.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a network streaming apparatus and an external wireless AP in an embodiment of the present invention; and

FIG. 2 is a network streaming apparatus operation method in an embodiment of the present invention.

### DETAILED DESCRIPTION

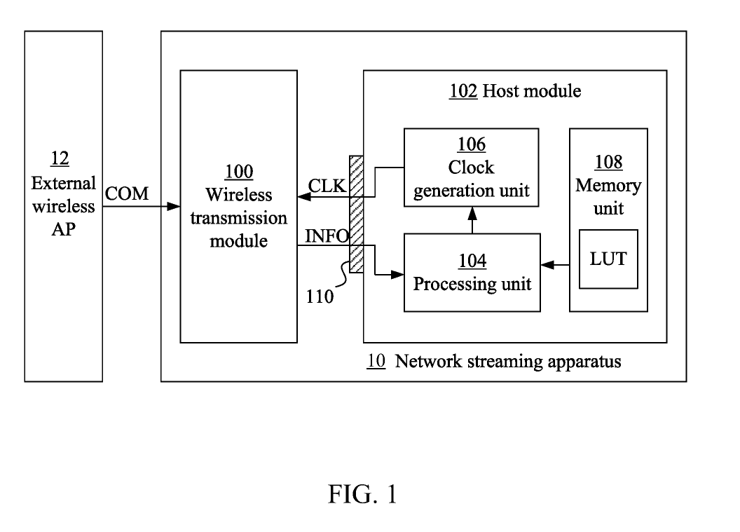

Reference is now made to FIG. 1. FIG. 1 is a block diagram of a network streaming apparatus 10 and an external wireless AP 12 in an embodiment of the present invention.

In an embodiment, the network streaming apparatus 10 can be such as, but not limited to an internet protocol television (IPTV) or a set top box (STB). The network streaming apparatus 10 is configured to access the external wireless AP 12 to retrieve a media stream of the network through the external wireless AP 12 and provide the media stream to such as, but not limited to a media playback apparatus (not illustrated) of a television to be playback. However, in other embodiments, the network streaming apparatus 10 can be other types of streaming apparatus.

The network streaming apparatus 10 includes a wireless transmission module 100 and a host module 102.

The wireless transmission module 100 is configured to perform wireless communication with the external wireless AP 12 through a wireless channel of a wireless frequency band. In an embodiment, the wireless transmission module 100 is a WiFi network module to perform wireless communication with the external wireless AP 12 through the WiFi communication protocol. In an embodiment, the wireless frequency band is such as, but not limited to the frequency band of 2.4 GHz defined in the WiFi communication protocol.

In an embodiment, after the wireless transmission module 100 and the external wireless AP 12 establish the connection, the external wireless AP 12 determines the wireless channel in the wireless frequency band used to perform communication. The wireless transmission module 100 receives a channel setting command COM from the external wireless AP 12 and sets the channel according to the channel setting command COM. The wireless transmission module 100 further performs wireless communication with the external wireless AP 12 according to the wireless channel determined by the external wireless AP 12.

The host module 102 is configured to be electrically coupled to the wireless transmission module 100. In an embodiment, the host module 102 generates a clock signal CLK to the wireless transmission module 100 according to a frequency range of the wireless channel such that the wireless transmission module 100 operates according to the clock signal CLK.

The detail embodiment of the host module 102 is further described in the following paragraphs.

In an embodiment, the host module 102 includes a processing unit 104, a clock generation unit 106, a memory unit 108 and a secure digital input/output (SDIO) interface 110.

The processing unit 104 is electrically coupled to the wireless transmission module 100 through the SDIO interface 110 such that the processing unit 104 performs the bi-directional communication with the wireless transmission module 100 through the SDIO interface 110. It is appreciated that in other embodiments, the host module 102 may include other types of signal transmission interfaces such that the host module 102 is coupled to and perform communication with the wireless communication module 100 through such interfaces.

In an embodiment, the wireless transmission module 100 transmits channel configuring information INFO related to the wireless channel to the processing unit 104 of the host module 102. For example, the channel configuring information INFO may include such as, but not limited to information of the number, the central frequency, the frequency range or a combination thereof of the wireless channel.

The processing unit 104 determines the operation frequency of the clock signal CLK according to the frequency range of the wireless channel and controls the clock generation unit 106 to generate the clock CLK signal having the operation frequency. The plurality of harmonics generated by the clock signal CLK according to the operation frequency are not within the frequency range.

Reference is now made to Table 1 and Table 2 at the same time. Table 1 is a table of the numbers of the channels included in the wireless frequency band of the 2.4 GHz WiFi communication protocol, the corresponding central frequency and the corresponding frequency range in an embodiment of the present invention. Table 2 is a table of the harmonic frequency generated by the clock signal CLK according to different operation frequencies corresponding to different wireless channels.

TABLE 1

| 2.4 GHz | Central frequency | Up | | Down | |
|---|---|---|---|---|---|
| Channel 1 | 2412 | 2402 | 2442 | | |
| Channel 2 | 2417 | 2407 | 2447 | | |
| Channel 3 | 2422 | 2412 | 2452 | | |
| Channel 4 | 2427 | 2417 | 2457 | | |
| Channel 5 | 2432 | 2422 | 2462 | 2402 | 2442 |
| Channel 6 | 2437 | 2427 | 2467 | 2407 | 2447 |
| Channel 7 | 2442 | 2432 | 2472 | 2412 | 2452 |
| Channel 8 | 2447 | 2437 | 2477 | 2417 | 2457 |
| Channel 9 | 2452 | 2442 | 2482 | 2422 | 2462 |
| Channel 10 | 2457 | | | 2427 | 2467 |
| Channel 11 | 2462 | | | 2432 | 2472 |
| Channel 12 | 2467 | | | 2437 | 2477 |
| Channel 13 | 2472 | | | 2442 | 2482 |

TABLE 2

| | | | | x(N + 1) |
|---|---|---|---|---|
| 2.4 GHz | xN (Up) | x(N + 1) (Up) | xN (Down) | (Down) |
| Channel 1 | 2396.719 | 2446.65 | | |
| Channel 2 | 2403.967 | 2453.027 | | |
| Channel 3 | 2407.406 | 2457.561 | | |
| Channel 4 | 2411.906 | 2462.154 | | |
| Channel 5 | 2417.748 | 2467.09 | 2396.719 | 2446.65 |
| Channel 6 | 2422.342 | 2471.777 | 2403.967 | 2453.027 |
| Channel 7 | 2428.275 | 2477.832 | 2407.406 | 2457.561 |
| Channel 8 | 2433.061 | 2482.715 | 2411.906 | 2462.154 |
| Channel 9 | 2437.463 | 2487.207 | 2417.748 | 2467.09 |
| Channel 10 | | | 2422.342 | 2471.777 |
| Channel 11 | | | 2428.275 | 2477.832 |
| Channel 12 | | | 2433.061 | 2482.715 |
| Channel 13 | | | 2437.463 | 2487.207 |

In Table 1, take the channel 1 as an example, the central frequency of the channel 1 is 2412 MHz and the frequency range of the channel 1 is 2402 MHz to 2442 MHz. In some of the channels (e.g. the channel 5 to the channel 9), since the formats supported by the external wireless AP 12 may be different, the central frequency may be different as well. As a result, each of these channels may correspond to a frequency range labeled as “Up” and a frequency range labeled as “down”.

In Table 2, the operation frequency of the clock signal CLK is substantially set to be 50 MHz. It is appreciated that the term “substantially” means that there can be a tiny difference between the clock signal CLK and the precise 50 MHz (i.e. the clock signal CLK can be slightly larger than or slightly smaller than 50 MHz). By slightly adjusting the tiny difference, a plurality of harmonics shown in Table 2 can be generated periodically.

For example, as illustrated in Table 1, when the wireless channel of the wireless transmission module 100 is set to be the channel 1, the central frequency thereof is 2412 MHz, and the frequency range is between 2402 MHz and 2442 MHz.

The processing unit 104 can set the operation frequency of the clock signal CLK according to Table 2 such that the clock signal generation unit 106 generates the harmonics periodically based on the operation frequency. Among these harmonics, the N-th harmonic having the frequency of 2396.719 MHz and the N+1-th harmonic having the frequency of 2446.65 MHz are closest to the frequency range of the channel 1, in which the two harmonics are separated from each other by 49.931 MHz, i.e. the operation frequency of the clock signal CLK.

As a result, the N-th harmonic is below the frequency range of the channel 1, and the N+1-th harmonic is above the frequency range of the channel 1. The harmonics of the clock signal CLK generated based on this operation frequency is not within the frequency range of the channel 1.

In another example, as illustrated in Table 1, when the wireless channel of the wireless transmission module 100 is set to be the channel 5, the frequency range is between 2422 MHz and 2462 MHz when the format supported by the external wireless AP 12 corresponds to the “Up” frequency range. The processing unit 104 can set the operation frequency of the clock signal CLK according to Table 2 such that the N-th harmonic and the N+1-th harmonics are 2417.748 MHz and 2467.09 MHz respectively. The two harmonics are separated from each other by 49.342 MHz, which is the operation frequency of the clock signal CLK. The harmonics of the clock signal CLK generated based on this operation frequency is not within the “Up” frequency range of the channel 5.

The frequency range is between 2402 MHz and 2442 MHz when the format supported by the external wireless AP 12 corresponds to the “Down” frequency range. The processing unit 104 can set the operation frequency of the clock signal CLK according to Table 2 such that the N-th harmonic and the N+1-th harmonics are 2396.719 MHz and 2446.65 MHz respectively. The two harmonics are separated from each other by 49.931 MHz, which is the operation frequency of the clock signal CLK. The harmonics of the clock signal CLK generated based on this operation frequency is not within the “Down” frequency range of the channel 5.

In an embodiment, the relation between Table 1 and Table 2 can be implemented as a look-up table LUT stored in the memory unit 108. The corresponding relation of the frequency range of the wireless channels and the operation frequency and the harmonics of the clock signal CLK can be recorded in the look-up table LUT. The processing unit 104 can retrieve the look-up table LUT from the memory unit 108 according to the frequency range of the wireless channel to select the operation frequency of the clock signal CLK based on the look-up table LUT to control the clock generation unit 106 to generate the clock signal CLK having the operation frequency.

In other embodiments, the processing unit 104 can also perform real-time calculation after receiving the related information of the wireless channel to obtain the appropriate value of the clock signal CLK. The present invention is not limited by the embodiment of the look-up table LUT.

As a result, the network streaming apparatus 10 of the present invention can determine the operation frequency of the clock signal CLK according to the frequency range of the wireless channel set by the wireless transmission module 100 such that the harmonics of the clock signal CLK are not within the frequency range of the wireless channel. Additional filtering capacitor configured to suppress the noise caused by the harmonics is not required to be disposed in the wireless transmission module 100.

By using the method described above, not only the effect on the original signal of the wireless channel caused by the filtering capacitor can be avoided, the space for disposing the filtering capacitor can be saved as well while the interference of the harmonics of the clock signal CLK on the wireless channel can be avoided effectively.

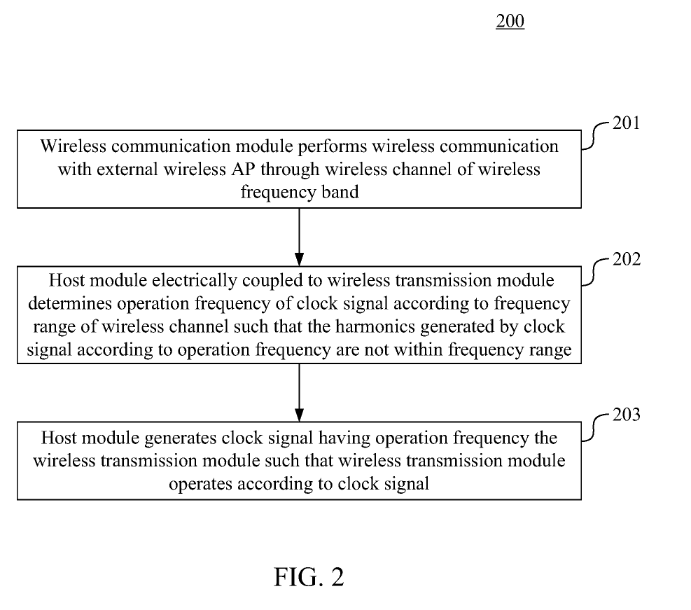

Reference is now made to FIG. 2. FIG. 2 is a network streaming apparatus operation method 200 in an embodiment of the present invention. The network streaming apparatus operation method 200 can be used in the network streaming apparatus 10 illustrated in FIG. 1. The network streaming apparatus operation method 200 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 201, wireless communication is performed with the external wireless AP 12 through the wireless channel of the wireless frequency band by the wireless communication module 100.

In step 202, the operation frequency of the clock signal CLK is determined according to the frequency range of the wireless channel by the host module 102 electrically coupled to the wireless transmission module 100 such that the harmonics generated by the clock signal CLK according to the operation frequency are not within the frequency range.

In step 203, the clock signal CLK having the operation frequency is generated to the wireless transmission module 100 by the host module 102 such that the wireless transmission module 100 operates according to the clock signal CLK.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A network streaming apparatus comprising:
a wireless transmission module configured to perform wireless communication with an external wireless access point (AP) through a wireless channel of a wireless frequency band; and
a host module configured to be electrically coupled to the wireless transmission module and to generate a clock signal to the wireless transmission module according to a frequency range of the wireless channel such that the wireless transmission module operates according to the clock signal;
wherein the host module determines an operation frequency of the clock signal according to the frequency range of the wireless channel such that a plurality of harmonics generated by the clock signal according to the operation frequency are not within the frequency range.

2. The network streaming apparatus of claim 1, wherein the host module further comprises:
a clock generation unit; and
a processing unit electrically coupled to the clock generation unit and configured to receive channel configuring information related to the wireless channel from the wireless transmission module to control the clock generation unit generates the clock signal according to the frequency range of the wireless channel.

3. The network streaming apparatus of claim 2, wherein the host module further comprises a memory unit configured to store a look-up table that is configured to store different corresponding relations between the frequency range of the wireless channel and the harmonics generated by the operation frequency;
wherein the processing unit is electrically coupled to the memory unit to retrieve the look-up table therefrom and to select the operation frequency according to the frequency range of the wireless channel.

4. The network streaming apparatus of claim 2, wherein the host module comprises a secure digital input/output (SDIO) interface, and the host module is electrically coupled to the wireless transmission module through the SDIO interface such that the processing unit receives the channel configuring information from the wireless transmission module through the SDIO interface and the clock generation unit transmits the clock signal to the wireless transmission module through the SDIO interface.

5. The network streaming apparatus of claim 1, wherein the wireless transmission module is further configured to receive a channel setting command of the external wireless AP to perform the wireless communication with the external wireless AP through the wireless channel according to the channel setting command.

6. The network streaming apparatus of claim 1, wherein the clock signal generates an N-th harmonic and an N+1-th harmonic closest to the frequency range of the wireless channel according to the operation frequency, wherein the N-th harmonic is below the frequency range and the N+1-th harmonic is above the frequency range.

7. The network streaming apparatus of claim 1, wherein the wireless transmission module performs wireless communication with the external wireless AP through a WiFi protocol.

8. The network streaming apparatus of claim 1, wherein the network streaming apparatus is an internet protocol television (IPTV) or a set top box (STB).

9. The network streaming apparatus of claim 1, wherein the host module is further configured to access the external wireless AP through the wireless transmission module to transmit a media stream to a media playback apparatus to be playback.

10. A network streaming apparatus operation method used in a network streaming apparatus, wherein the network streaming apparatus operation method comprises:
performing wireless communication with an external wireless AP through a wireless channel of a wireless frequency band by a wireless communication module;
determining an operation frequency of a clock signal according to a frequency range of the wireless channel by a host module electrically coupled to the wireless transmission module such that a plurality of harmonics generated by the clock signal according to the operation frequency are not within the frequency range; and
generating the clock signal having the operation frequency to the wireless transmission module by the host module such that the wireless transmission module operates according to the clock signal.
